(19) United States
(12) Patent Application Publication
(10) Pub. No.: US 2025/0188107 A1
(43) Pub. Date: Jun. 12, 2025

(54) ORGANOMETALLIC COMPOUNDS, AND PREPARATION AND USE THEREOF

(71) Applicant: UMICORE AG & CO. KG, Hanau-Wolfgang (DE)

(72) Inventors: Viktoria DAESCHLEIN-GESSNER, Herne (DE); Ilja RODSTEIN, Mülheim an der Rurh (DE); Thorsten SCHERPF, Würzburg (DE); Angelino DOPPIU, Seligenstadt (DE)

(73) Assignee: UMICORE AG & CO. KG, Hanau-Wolfgang (DE)

(21) Appl. No.: 18/846,448

(22) PCT Filed: Apr. 6, 2023
(86) PCT No.: PCT/EP2023/059153

§ 371 Date: Sep. 12, 2024

(30) Foreign Application Priority Data
Apr. 14, 2022 (EP) 22168420.2

(51) Int. Cl. C07F 15/00; B01J 31/24

(52) U.S. Cl. CPC C07F 15/0066; B01J 31/2495; B01J 2231/4205; B01J 2231/4283; B01J 2231/4288; B01J 2531/824; B01J 2540/54

(57) ABSTRACT

The present patent application relates to new palladium complexes, to processes for their preparation, and to their use.

Numerous organometallic compounds, in particular palladium compounds, are known as catalysts in chemical synthesis. Numerous palladium-catalyzed reactions, such as Heck and Stille reactions, the Hartwig-Buchwald reaction, Negishi coupling, Suzuki coupling and Sonogashira coupling are established in preparative organic chemistry.

Nevertheless, there is a continued need for new catalysts which cover specific requirements or have new properties in order to expand and supplement the range of preparative chemistry.

WO 2017/093427 describes, for example, a palladium-catalyzed selective arylation process.

WO 2019/030304 shows the use of novel ligands for preparing metal complexes and their use in organometallic catalysis.

Surprisingly, it has now been found that such ligands can form new, hitherto unknown, and catalytically active palladium complexes.

### BRIEF DESCRIPTION OF THE INVENTION

1. A compound of formula I or II

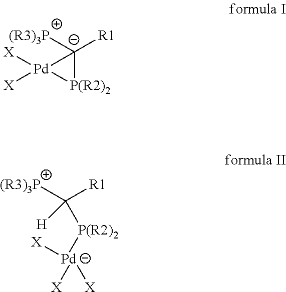

wherein X is halogen, R1 is alkyl, perfluoroalkyl, aryl or cycloalkyl, in each case substituted or unsubstituted, cyano, sulfonyl —SO2—R10 with R10=C1-C5 alkyl, C5-C6 cycloalkyl, C5-C10 aryl, in each case unsubstituted or substituted with C1 to C4 alkyl or C1 to C4 perfluoroalkyl, silyl —Si(R20R30R40) with R20, R30 and R40, which each independently of one another are C1-C6 alkyl or C5-C10 aryl, in each case unsubstituted or substituted with C1 to C4 alkyl,

R2 is alkyl or cycloalkyl, adamantyl and aryl, and

R3 is alkyl, cycloalkyl and aryl.

2. A compound according to point 1, wherein X is chlorine, bromine, iodine or combinations thereof.

3. A compound according to one or more of the preceding points, wherein R1 is C1 to C9 alkyl, C4-C8 cycloalkyl, cyano, sulfonyl —SO2-R10 with R10=C1-C5 alkyl, C5-C6 cycloalkyl, C5-C10 aryl, in each case unsubstituted or mono-or polysubstituted with C1 to C4 alkyl, C1 to C4 alkoxy or C1 to C4 perfluoroalkyl, silyl —Si(R20R30R40) with R20, R30 and R40, which each independently of one another are C1-C6 alkyl or C5-C10 aryl, in each case unsubstituted or substituted with C1 to C4 alkyl, or R1 is C5-C10 aryl which may be mono-or polysubstituted with C1 to C5 alkyl, C1 to C5 alkoxy or C1 to C5 perfluoroalkyl.

4. A compound according to one or more of the preceding points, wherein R2 is C1 to C9 alkyl, C4-C9 cycloalkyl, adamantyl or C5-C10 aryl, which may be mono-or polysubstituted with C1 to C5 alkyl, C1 to C5 alkoxy, or C1 to C5 perfluoroalkyl.

5. A compound according to one or more of the preceding points, wherein R3 is C1-C12 alkyl, C4-C8 cycloalkyl, C5-C10 aryl, which may be mono- or polysubstituted with C1 to C5 alkyl, C1 to C5 alkoxy or.

6. A compound according to one or more of the preceding points, wherein R1 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, menthyl, phenyl, o-toluyl, naphtyl, o-methoxyphenyl, o-ethoxyphenyl, di-(o-methoxy) phenyl, p-trifluoromethylphenyl, trimethylsilyl, triisopropylsilyl, tri-tert-butylsilyl, cyano, methylsulfonyl, toluylsulfonyl and trifluoromethylsulfonyl.

7. A compound according to one or more of the preceding points, wherein R2 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, 1-adamantyl, 2-adamantyl, phenyl, o-, m-, or p-methylphenyl, naphthyl.

8. A compound according to one or more of the preceding points, wherein R3 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, cyclobutyl, cyclopentyl, cyclohexyl, phenyl.

9. A compound according to one or more of the preceding points, wherein R2 is C1 to C9 alkyl or C4-C9 cycloalkyl and R3 is C1 to C12 alkyl or C4-C8 cycloalkyl, in particular wherein R2 and R3 are C4-C8 cycloalkyl.

10. A compound according to point 9, wherein R2 and R3 are cyclohexyl, or wherein R2 is tert-butyl and R3 is cyclohexyl.

11. A compound according to one or more of the preceding points, wherein X is chlorine or bromine.

12. A compound according to one or more of the preceding points, wherein R1 is selected from the group consisting of methyl, phenyl, o-toluyl and o-methoxyphenyl.

13. A process for preparing compounds according to one or more of points 1 to 12 according to formula I, wherein a ligand of type R1—C—(P(R2)₂)(P(R3)₃), wherein R1, R2 and R3 are as defined in the preceding points, is reacted with a palladium compound of type PdX₂ or Lₙ (PdX₂), wherein X, as defined above, is halogen, L is a neutral electron donor ligand, and n=1 or 2.

14. A process for preparing compounds according to one or more of points 1 to 12 according to formula II, wherein a ligand of type R1—CH—(P(R2)₂)(P(R3)₃)(X), wherein R1, R2 and R3 are as defined in the preceding points, is reacted with a palladium compound of type H₂PdX₄, PdX₂ or Lₙ (PdX₂), wherein X, as defined above, is halogen, L is a neutral electron donor ligand and n=1 or 2.

15. A process according to point 13 or 14, wherein the reactants react in a solvent, in particular a polar solvent mixture, in particular containing tetrahydrofuran, dichloromethane, acetone, ethanol, ethyl acetate or acetonitrile.

16. A process according to one of the preceding points 13 to 15, wherein L is acetonitrile, dimethyl sulfoxide, dibenzylidene acetone or 1,5-cyclooctadiene.

17. A process according to one of the preceding points 13 to 16, wherein the palladium compound of type Lₙ(PdX₂) is selected from the group consisting of (CH₃CN)₂PdCl₂, (COD) PdCl₂ and (DBA) PdCl₂.

18. A process according to one of the preceding points 13 to 16, wherein a palladium compound of type PdX₂ is used and X is advantageously Cl or Br.

19. A process according to point 14, wherein the palladium compound of type PdX₂ is used in an acidic solution which contains in particular water.

20. A process for performing a coupling reaction, comprising the following steps:
providing a reaction mixture containing at least one substrate, a coupling partner and at least one metal complex according to one of points 1 to 12; and
reacting the substrate with the coupling partner in the presence of the metal complex or its derivative to form a coupling product.

21. A process for performing a coupling reaction, comprising the following steps:
providing a metal complex according to a process according to at least one of points 13 to 19;
providing a reaction mixture containing at least one substrate, a coupling partner and the metal complex; and
reacting the substrate with the coupling partner in the presence of the metal complex or its derivative to form a coupling product.

22. A process according to one or more of points 20 to 21, wherein the substrate is a substituted aromatic compound.

23. A process according to point 22, wherein the substituted aromatic compound is an aromatic or heteroaromatic compound.

24. A process according to point 22 or 23, wherein the substituted aromatic compound is substituted with a leaving group and/or an unsaturated aliphatic group or a leaving group.

25. A process according to point 24, wherein the leaving group is selected from the group consisting of halogen, triflate, tosylate, nosylate and mesylate, and/or the unsaturated aliphatic group is selected from the group consisting of alkene or alkyne, in particular having 2 to 12, in particular having 2 to 8 carbon atoms.

26. A process according to one or more of the preceding points, wherein the coupling partner is an organometallic compound.

27. A process according to point 26, wherein the organometallic compound is selected from the group consisting of organic boron compounds, organolithium compounds, organozinc compounds, organolithium compounds and Grignard compounds.

28. A process according to point 26 or 27, wherein the organometallic compound comprises at least one aromatic group.

29. A process according to point 26 or 27, wherein the organometallic compound comprises at least one unsaturated aliphatic group.

30. A process according to point 26 or 27, wherein the organometallic compound comprises at least one saturated aliphatic group.

31. A process according to one or more of points 20 to 30, wherein the coupling reaction can be selected from the group consisting of:
(i) catalytic hydrofunctionalization reactions of alkynes and alkenes;
(ii) catalytic hydroamination reactions of alkynes and alkenes;
(iii) catalytic O—H addition reactions on alkynes and alkenes;
(iv) catalytic coupling reactions;
(v) catalytic Kumada coupling reactions, Murahashi coupling reactions, Negishi coupling reactions or Suzuki coupling reactions, in particular for the preparation of biarylene;
(vi) catalytic cross-coupling reactions, in particular C—N and C—O coupling reactions, such as the Hartwig-Buchwald coupling; and/or
(vii) catalytic Heck coupling reactions, in particular for the preparation of arylated olefins, and Sonogashira coupling reactions, in particular for the preparation of arylated and alkenylated alkynes.

### DETAILED DESCRIPTION OF THE INVENTION

Surprisingly, it has been found that compounds of the formula I or II

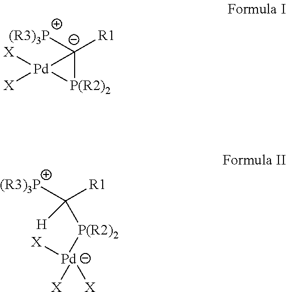

wherein

X is halogen,

R1 is alkyl, perfluoroalkyl, aryl or cycloalkyl, in each case substituted or unsubstituted, cyano, sulfonyl —SO2—R10 with R10=C1-C5 alkyl, C5-C6 cycloalkyl, C5-C10 aryl, in each case unsubstituted or substituted with C1 to C4 alkyl or C1 to C4 perfluoroalkyl, silyl —Si(R20R30R40) with R20, R30 and R40, which each independently of one another are C1-C6 alkyl or C5-C10 aryl, in each case unsubstituted or substituted with C1 to C4 alkyl,

R2 is alkyl, cycloalkyl, adamantyl or aryl, and

R3 is alkyl, cycloalkyl and aryl,

can be obtained by reacting a ligand of type R1—C—(P(R2)₂)(P(R3)₃) or R1—CH—(P(R2)₂)(P(R3)₃)(X), wherein R1, R2 and R3 are as defined above, with a palladium compound of type M₂PdX₄, PdX₂ or Lₙ(PdX₂), wherein X, as defined above, is halogen, M is hydrogen (H) or sodium (Na), L is a neutral electron donor ligand, and n=1 or 2.

Surprisingly, these new compounds have a catalytic activity in various coupling reactions.

Halogen X is in particular chlorine, bromine, iodine or combinations thereof, advantageously chlorine, bromine or combinations thereof.

L is a neutral electron donor ligand. In specific embodiments, L is selected from the group consisting of nitriles, sulfoxides, ketones, dienes and diamines.

Particularly suitable nitriles are compounds of the formula R20—CN, such as acetonitrile (CH₃CN).

Suitable sulfoxides are compounds of formula R50—(S═O)-R60, wherein R50 and R60 are each independently of one another C1-C6 alkyl, C5-C6 cycloalkyl or C5-C10 aryl, in each case unsubstituted or substituted with C1 to C4 alkyl, or wherein R50 and R60 together comprise three to seven carbon atoms and with the sulfoxide group form a four- to eight-membered, in particular five-or six-membered ring, such as dimethyl sulfoxide (DMSO), dibutyl sulfoxide, diphenyl sulfoxide or tetrahydrothiophene-1-oxide.

Suitable ketones are compounds of formula R70—(C═O)—R80, wherein R70 and R80 are each independently of one another C1-C6 alkyl, C1-C6 alkenyl, C5-C6 cycloalkyl, C5-C10 aryl, or C7 to C12 arylidene, in each case unsubstituted or substituted with C1 to C4 alkyl, such as dibenzylidene acetone (DBA).

Suitable dienes in principle are all dialkenes which complex palladium, such as 1,5-cyclooctadiene (COD) or norbornadiene (NBD).

Suitable diamines are generally diamines which complex palladium, such as 1,2-diaminocyclohexane or N,N,N′,N′-tetramethylethylenediamine, often also referred to as TMEDA.

R1 is C1 to C9 alkyl, C4-C8 cycloalkyl, cyano, sulfonyl —SO2—R10 with R10=C1-C5 alkyl, C5-C6 cycloalkyl, C5-C10 aryl, in each case unsubstituted or mono-or polysubstituted with C1 to C4 alkyl, C1 to C4 alkoxy or C1 to C4 perfluoroalkyl, silyl —Si (R20R30R40) with R20, R30 and R40, which each independently of one another are C1-C6 alkyl or C5-C10 aryl, in each case unsubstituted or substituted with C1 to C4 alkyl, or R1 is C5-C10 aryl which may be substituted with C1 to C5 alkyl, C1 to C5 alkoxy or C1 to C5 perfluoroalkyl.

In particular, R1 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, menthyl, phenyl, o-toluyl, naphtyl, o-methoxyphenyl, o-ethoxyphenyl, di-(o-methoxy) phenyl, p-trifluoromethylphenyl, trimethylsilyl, triisopropylsilyl, tri-tert-butylsilyl, cyano, methylsulfonyl, toluylsulfonyl and trifluoromethylsulfonyl; or
R1 is selected from the group consisting of methyl, phenyl, o-toluyl and o-methoxyphenyl.

R2 is C1 to C9 alkyl, C4-C9 cycloalkyl, adamantyl or C5-C10 aryl, which may be substituted with C1 to C5 alkyl, C1 to C5 alkoxy or C1 to C5 trifluoroalkyl or perfluoroalkyl.

In particular, R2 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, 1-adamantyl, 2-adamantyl, phenyl, o-, m-, or p-methylphenyl, naphthyl; or
R2 is selected from methyl, isopropyl, tert-butyl, phenyl and cyclohexyl; or
R2 is selected from tert-butyl, isopropyl and cyclohexyl.

R3 is C1-C12 alkyl, C4-C8 cycloalkyl and C5-C10 aryl which may be substituted with C1 to C5 alkyl, C1 to C5 alkoxy or.

In particular, R3 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, cyclobutyl, cyclopentyl, cyclohexyl, phenyl; or
R3 is selected from phenyl and cyclohexyl.

In a specific embodiment, R2 is C1 to C9 alkyl or C4-C9 cycloalkyl, for example 1-adamantyl or 2-adamantyl, and R3 is C1 to C12 alkyl or C4-C8 cycloalkyl.

In a further embodiment, R2 and R3 are C4-C9 cycloalkyl.

In each of these embodiments, R1 can be C1 to C9 alkyl, in particular C1 to C4 alkyl, C4-C8 cycloalkyl or C5-C10 aryl, in particular C1-C3 alkyl or C5-C6 aryl, which may be substituted with C1 to C5 alkyl or C1 to C5 alkoxy, in particular C1 to C3 alkyl or C1 to C3 alkoxy. In these cases, X is selected from the group consisting of Cl, Br, I and combinations thereof, in particular Cl, Br and combinations thereof.

In further specific embodiments, R2 and R3 are cyclohexyl or R2 is tert-butyl or isopropyl and R3 is cyclohexyl. In each of these embodiments, R1 can be selected from the group consisting of methyl, isopropyl, phenyl, o-tolyl and o-methoxyphenyl. In these cases, X is selected from the group consisting of Cl, Br, I and combinations thereof, in particular Cl, Br and combinations thereof.

In a further embodiment, R1 is selected from the group consisting of methyl, isopropyl, phenyl, o-tolyl and o-methoxyphenyl, R2 is selected from isopropyl, tert-butyl, phenyl and cyclohexyl, R3 is selected from phenyl and cyclohexyl, and X is selected from the group consisting of Cl, Br, I and combinations thereof.

Specific combinations are listed in Tables 1 to 7 below.

TABLE 1

| No. | R1 | R2 |
|---|---|---|
| 1 | methyl | methyl |
| 2 | iso-propyl | methyl |
| 3 | phenyl | methyl |
| 4 | o-tolyl | methyl |
| 5 | o-methoxyphenyl | methyl |
| 6 | methyl | tert-Butyl |
| 7 | iso-propyl | tert-Butyl |
| 8 | phenyl | tert-Butyl |
| 9 | o-tolyl | tert-Butyl |
| 10 | o-methoxyphenyl | tert-Butyl |
| 11 | methyl | phenyl |
| 12 | iso-propyl | phenyl |
| 13 | phenyl | phenyl |
| 14 | o-tolyl | phenyl |
| 15 | o-methoxyphenyl | phenyl |
| 16 | methyl | cyclohexyl |
| 17 | iso-propyl | cyclohexyl |
| 18 | phenyl | cyclohexyl |
| 19 | o-tolyl | cyclohexyl |
| 20 | o-methoxyphenyl | cyclohexyl |
| 21 | methyl | iso-propyl |
| 22 | iso-propyl | iso-propyl |
| 23 | phenyl | iso-propyl |
| 24 | o-tolyl | iso-propyl |
| 25 | o-methoxyphenyl | iso-propyl |
| 26 | methyl | 1-adamantyl |
| 27 | iso-propyl | 1-adamantyl |
| 28 | phenyl | 1-adamantyl |
| 29 | o-tolyl | 1-adamantyl |
| 30 | o-methoxyphenyl | 1-adamantyl |
| 31 | methyl | 2-adamantyl |
| 32 | iso-propyl | 2-adamantyl |
| 33 | phenyl | 2-adamantyl |
| 34 | o-tolyl | 2-adamantyl |
| 35 | o-methoxyphenyl | 2-adamantyl |

Table 2 shows the 35 compounds 2.01 to 2.35 of formula I and the 35 compounds 2.36 to 2.70 of formula II, wherein R1 and R2 have the meanings defined in Table 1, R3 is phenyl, and X is Cl.

Table 3 shows the 35 compounds 3.01 to 3.35 of formula I and the 35 compounds 3.36 to 3.70 of formula II, wherein R1 and R2 have the meanings defined in Table 1, R3 is cyclohexyl, and X is Cl.

Table 4 shows the 35 compounds 4.01 to 4.35 of formula I and the 35 compounds 4.36 to 4.70 of formula II, wherein R1 and R2 have the meanings defined in Table 1, R3 is phenyl, and X is Br.

Table 5 shows the 35 compounds 3.01 to 3.35 of formula I and the 35 compounds 3.36 to 3.70 of formula II, wherein R1 and R2 have the meanings defined in Table 1, R3 is cyclohexyl, and X is Br.

Table 6 shows the 35 compounds 6.01 to 6.35 of formula I and the 35 compounds 6.36 to 6.70 of formula II, wherein R1 and R2 have the meanings defined in Table 1, R3 is phenyl, and X is I.

Table 7 shows the 35 compounds 7.01 to 7.35 of formula I and the 35 compounds 7.36 to 7.70 of formula II, wherein R1 and R2 have the meanings defined in Table 1, R3 is cyclohexyl, and X is I.

The compounds of formula I can be obtained by a process, wherein a ligand of type R1—C—(P(R2)₂)(P(R3)₃), wherein R1, R2 and R3 are as defined above, is reacted with a palladium compound of type PdX₂ or Lₙ(PdX₂), wherein X, as defined above, is halogen, L is a neutral electron donor ligand, and n=1 or 2.

The ligand used of type R1—C—(P(R2)₂)(P(R₃)₃) has the structure of formula III.

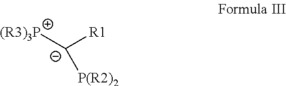

The substituents R1, R2 and R3 are as defined above. In particular, the substituents R1, R2 and R3 may be as defined in the following Table 8.

| No. | R1 | R2 | R3 | Name |
|---|---|---|---|---|
| 1 | phenyl | tert-butyl | phenyl | |
| 2 | phenyl | phenyl | phenyl | |
| 3 | phenyl | methyl | phenyl | |
| 4 | phenyl | cyclohexyl | phenyl | |
| 5 | phenyl | tert-butyl | cyclohexyl | |
| 6 | phenyl | phenyl | cyclohexyl | |
| 7 | phenyl | methyl | cyclohexyl | |
| 8 | phenyl | cyclohexyl | cyclohexyl | joYPhos |
| 9 | methyl | tert-butyl | phenyl | |
| 10 | methyl | phenyl | phenyl | |
| 11 | methyl | methyl | phenyl | |
| 12 | methyl | cyclohexyl | phenyl | |
| 13 | methyl | isopropyl | cyclohexyl | prYPhos |
| 14 | methyl | tert-butyl | cyclohexyl | trYPhos |
| 15 | methyl | phenyl | cyclohexyl | |
| 16 | methyl | methyl | cyclohexyl | |
| 17 | methyl | cyclohexyl | cyclohexyl | keYPhos |
| 18 | trimethylsilyl | tert-butyl | phenyl | |
| 19 | trimethylsilyl | phenyl | phenyl | |
| 20 | trimethylsilyl | methyl | phenyl | |
| 21 | trimethylsilyl | cyclohexyl | phenyl | |
| 22 | trimethylsilyl | tert-butyl | cyclohexyl | |
| 23 | trimethylsilyl | phenyl | cyclohexyl | |
| 24 | trimethylsilyl | methyl | cyclohexyl | |
| 25 | trimethylsilyl | cyclohexyl | cyclohexyl | |
| 26 | toluoysulfonyl | tert-butyl | phenyl | |
| 27 | toluoysulfonyl | phenyl | phenyl | |
| 28 | toluoysulfonyl | methyl | phenyl | |
| 29 | toluoysulfonyl | cyclohexyl | phenyl | |
| 30 | toluoysulfonyl | tert-butyl | cyclohexyl | |
| 31 | toluoysulfonyl | phenyl | cyclohexyl | |
| 32 | toluoysulfonyl | methyl | cyclohexyl | |
| 33 | toluoysulfonyl | cyclohexyl | cyclohexyl | |
| 34 | o-tolyl | tert-butyl | phenyl | |
| 35 | o-tolyl | phenyl | phenyl | |
| 36 | o-tolyl | methyl | phenyl | |
| 37 | o-tolyl | cyclohexyl | phenyl | |
| 38 | o-tolyl | tert-butyl | cyclohexyl | |
| 39 | o-tolyl | phenyl | cyclohexyl | |
| 40 | o-tolyl | methyl | cyclohexyl | |
| 41 | o-tolyl | cyclohexyl | cyclohexyl | pinkYPhos |
| 42 | o-methoxyphenyl | tert-butyl | phenyl | |
| 43 | o-methoxyphenyl | phenyl | phenyl | |
| 44 | o-methoxyphenyl | methyl | phenyl | |
| 45 | o-methoxyphenyl | cyclohexyl | phenyl | |
| 46 | o-methoxyphenyl | tert-butyl | cyclohexyl | |
| 47 | o-methoxyphenyl | phenyl | cyclohexyl | |
| 48 | o-methoxyphenyl | methyl | cyclohexyl | |
| 49 | o-methoxyphenyl | cyclohexyl | cyclohexyl | oxYPhos |

The palladium compounds of type PdX₂ are the known palladium halides PdCl₂, PdBr₂ and PdI₂, in particular palladium chloride PdCl₂.

Palladium compounds of type Lₙ(PdX₂), wherein L is a neutral electron donor ligand and n=1 or 2, have likewise proven to be useful as reactant for the preparation of compounds of formulas I and II. If the neutral electron donor ligand is a monodentate ligand, then n=2, and, in the case of a bidentate ligand, n=1.

In specific embodiments, L is selected from the group consisting of acetonitrile (CH₃CN), dimethyl sulfoxide (DMSO), dibenzylideneacetone (DBA) and 1,5-cyclooctadiene (COD), norbornadiene (NBD).

For example, compounds such as (CH₃CN)₂PdCl₂, (COD) PdCl₂ or (DBA)PdCl₂ are well suited.

To prepare the compound according to formula II, a ligand can be used of type R1—CH—(P(R2)₂)(P(R3)₃) (X) of formula IV:

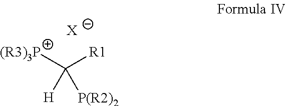

This can be obtained by acid treatment of a ligand of type R1—C—(P(R2)₂)(P(R3)₃) of formula III. For this purpose, the ligand is suspended in a suitable solvent, for example dichloromethane, and mixed with a suitable acid, for example with concentrated hydrochloric acid or HBF₄.

Subsequently, the mixture is reacted with a palladium compound. The palladium compounds of type PdX₂ are the known palladium halides PdCl₂, PdBr₂ and PdI₂, in particular palladium chloride PdCl₂.

In a strongly acidic aqueous solution, these compounds usually occur in the form of the corresponding acid H₂PdX₄, i.e., in the case of the palladium chloride in the form of compound H₂PdCl₄. These usually industrially produced, acidic solutions containing palladium halides, in particular palladium chloride or H₂PdX₄ or H₂PdCl₄, are suitable as reactants for the preparation of the compounds of formula II. The order of addition of the reactants is not critical in this procedure and leads to the same product with comparable purities and yields.

When using such an acidic solution of PdX₂, in particular PdCl₂ and/or PdBr₂, the ligand according to formula III can also be used; a ligand according to formula IV is then not required.

In a further embodiment, a compound according to formula II can be obtained by first producing a compound of formula I and subsequently obtaining this by acid treatment. For this purpose, the ligand is suspended in a suitable solvent, for example dichloromethane, and mixed, for example, with concentrated hydrochloric acid.

Conversely, a compound of formula II can also be converted into a compound of formula I by treatment with a base. Various alkali metal carbonates, alkali metal alcoholates HMDS and bases (hexamethylenedisilicides) such as sodium ethanolate or potassium ethanolate, sodium carbonate or potassium carbonate, and sodium hexamethyldisilacide or potassium hexamethyldisilacide (Na-HMDS or K-HMDS) are generally suitable for this purpose; potassium tert-butanolate and sodium carbonate have proven to be useful in practice. The reaction can be carried out in a solvent or mechanochemically. Solvents which can be used are, for example, alcohols such as ethanol or isopropanol, ethers such as tetrahydrofuran, or else aromatic solvents such as toluene.

Palladium compounds of type Lₙ(PdX₂), wherein L is a neutral electron donor ligand and n=1 or 2, have likewise proven to be useful as reactant for the preparation of compounds of formulas I and II. If the neutral electron donor ligand is a monodentate ligand, then n=2, and, in the case of a bidentate ligand, n=1.

In specific embodiments, L is selected from the group consisting of acetonitrile (CH₃CN), dimethyl sulfoxide (DMSO), dibenzylideneacetone (DBA) and 1,5-cyclooctadiene (COD).

For example, compounds such as (CH₃CN)₂PdCl₂, (COD)PdCl₂ or (DBA) PdCl₂ are well suited.

The reaction of the ligand according to formula III or formula IV with a palladium compound to give the compounds of formulas I or II can be carried out at temperatures of 0° C. to 100° C., in particular of 10° C. to 50° C., advantageously of 15° C. to 30° C., or at the respective room temperature. The reaction times are from 2 hours to 72 hours, in particular from 2 hours to 12 hours or from 2 hours to 8 hours or from 2 to 4 hours.

The reaction can be carried out in particular in a solvent. Polar solvents, usually polar aprotic solvents, are well suited, although in some cases good results were also achieved with ethanol. It may be advantageous to select water-miscible solvents.

When using an acidic palladium halide solution, in particular an acidic palladium chloride solution, a water-soluble solvent is required.

Particularly useful solvents are in particular tetrahydrofuran, dichloromethane, acetone, ethanol, ethyl acetate and acetonitrile.

The palladium complexes of formula I and formula II described above can be used in homogeneous catalysis, in particular in coupling reactions, wherein the coupling reaction can be selected from the group consisting of:
(i) catalytic hydrofunctionalization reactions of alkynes and alkenes;
(ii) catalytic hydroamination reactions of alkynes and alkenes;
(iii) catalytic O—H addition reactions on alkynes and alkenes;
(iv) catalytic coupling reactions;
(v) catalytic Kumada coupling reactions, Murahashi coupling reactions, Negishi coupling reactions or Suzuki coupling reactions, in particular for the production of biarylene;
(vi) catalytic cross-coupling reactions, in particular C—N and C—O coupling reactions; and/or
(vii) catalytic Heck coupling reactions, in particular for the production of arylated olefins, and Sonogashira coupling reactions, in particular for the production of arylated and alkenylated alkynes.

In addition, the patent application relates to a process for performing a coupling reaction comprising the steps of:
providing a reaction mixture containing at least substrate, coupling partner and at least one of the palladium complexes of formula I and formula II; and
reacting the substrate with the coupling partner in the presence of the metal complex or its derivative, so that a coupling product is formed.

In another embodiment, a process for performing a coupling reaction is carried out which comprises the following steps:
providing a metal complex according to a process as described above;
providing a reaction mixture containing at least one substrate, a coupling partner and the metal complex; and
reacting the substrate with the coupling partner in the presence of the metal complex or its derivative to form a coupling product.

The substrate may be a substituted unsaturated or substituted aromatic compound, in particular the substituted aromatic compound may be an aromatic or heteroaromatic compound.

This may be substituted, among other things, with a leaving group or an unsaturated aliphatic group or a leaving group, wherein it has proven useful if the leaving group is selected from the group consisting of halogen, triflate, tosylate, nosylate and mesylate, and/or the unsaturated aliphatic group is selected from the group consisting of alkene or alkyne, in particular having 2 to 12, in particular having 2 to 8 carbon atoms.

The coupling partner may comprise an organometallic compound, which may in particular be selected from the group consisting of organic boron compounds, organic lithium compounds, organic zinc compounds, organic lithium compounds and Grignard compounds, wherein the organometallic compound advantageously comprises at least one aromatic group, or wherein the organometallic compound comprises at least one unsaturated aliphatic group, or wherein the organometallic compound comprises at least one saturated aliphatic group.

The patent application also relates to such a process, wherein the coupling reaction is selected from the group consisting of:
(i) catalytic hydrofunctionalization reactions of alkynes and alkenes;
(ii) catalytic hydroamination reactions of alkynes and alkenes;
(iii) catalytic O—H addition reactions on alkynes and alkenes;
(iv) catalytic coupling reactions;
(v) catalytic Kumada coupling reactions, Murahashi coupling reactions, Negishi coupling reactions or Suzuki coupling reactions, in particular for the production of biarylene;
(vi) catalytic cross-coupling reactions, in particular C—N and C—O coupling reactions; and/or
(vii) catalytic Heck coupling reactions, in particular for the production of arylated olefins, and Sonogashira coupling reactions, in particular for the production of arylated and alkenylated alkynes.

The invention will be explained in greater detail with reference to the following examples. These are exemplary for the production of the palladium complexes, their preparation, and their use in catalysis and are in no way to be understood as limiting the scope of protection of the invention.

### EXAMPLES

### Example 1

Isolation of keYPhos.PdCl₂

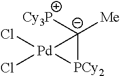

keYPhos (1.00 g, 1.98 mmol, 1.05 eq.) and Pd (CH₃CN)₂Cl₂ (0.49 g, 1.89 mmol, 1.00 eq.) were suspended in dry THF (30 ml) under inert gas. The reddish suspension was stirred further at room temperature for two days under inert gas. The solid was filtered under inert gas and washed three times with 10 ml of THF in each case. The product was dried under vacuum and obtained as a yellowish solid (1.24 g, 1.81 mmol, 96%).

¹H NMR (400 MHZ, CD₂Cl₂) δ=1.10-1.54 (m, 15H, CH₂, _{PCy3, H4+PCy2, H3+H4)}, 1.55-2.18 (m, 30H, CH, _{PCy2, H1}+CH₂, _{PCy3, H2+H3+H4, PCy2, H2+H3+H4}+CH₃), 2.31 (d, ³J_{HH}=12.0 Hz, 5H, CH₂, _{PCy2, H2+PCy3, H3,}), 2.47-2.83 (m, 8H, CH₂, _{PCy3, H2+PCy2, H2+}CH, _{PCy3, H1+PCy2, H1}) ppm.

¹³C{¹H} NMR (101 MHZ, CD₂Cl₂) δ=14.2 (dd, ¹J_{CP}=41.1 Hz, ¹J_{CP}=5.1 Hz, P—C⁻—P), 21.2 (CH₃), 26.0 (d, ⁴J_{CP}=1.9 Hz, CH₂, _{PCy2, C4}), 26.1 (d, ⁴J_{CP}=1.7 Hz, CH₂, _{PCy3, C4}), 26.3 (d, ⁴J_{CP}=2.0 Hz, CH₂, _{PCy2, C4}), 27.3-28.0 (m, CH₂, _{PCy2, C3}), 28.3 (d, ³J_{CP}=17.1 Hz, CH₂, _{PCy2, C3}), 28.5 (d, ²J_{CP}=3.6 Hz, CH₂, _{PCy3, C3}), 29.7 (d, ²J_{CP}=4.2 Hz, CH₂, _{PCy3, C2}), 29.7 (d, ²J_{CP}=2.7 Hz, CH_{2 PCy2, C2}), 31.2 (d, ³J_{CP}=7.9 Hz, CH₂, _{PCy2, C2}), 31.8 (d, ²J_{CP}=4.4 Hz, CH₂, _{PCy2, C2}), 32.1 (d, ²J_{CP}=3.9 Hz, CH₂, _{PCy2, C2}), 36.3 (d, ¹J_{CP}=39.2 Hz, CH, _{PCy3, C1}), 37.3 (d, ¹J_{CP}=20.3 Hz, CH, _{PCy2, C1}), 39.9 (d, ¹J_{CP}=15.0 Hz, CH, _{PCy2, C1}) ppm.

³¹P{¹H} NMR (162 MHZ, CD₂Cl₂) δ =37.1 (PCy₃), 48.6 (PCy₂) ppm.

CHNS: Calculated: C: 56.46, H: 8.53. Measured: C: 56.67, H: 8.72. IR: \tilde{v}=2929 (vs), 2847 (s), 1444 (s), 885 (m), 849 (vs), 838 (vs), 569 (w), 465 (m) cm⁻¹.

### Example 2

Alternative synthesis routes of keYPhos.PdCl₂

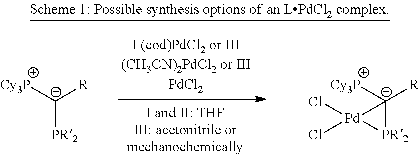

In addition to the isolation described in the previous chapter, the subsequent synthesis methods with PdCl₂ were likewise successfully performed:

Experiment 1: 0.5 g (2.82 mmol, 1 eq.) PdCl₂ are suspended in 20 ml of dry acetonitrile and stirred overnight to room temperature under inert gas. The solvent was removed under vacuum and, into the vessel in the glove box, there were added 1.6 g (3.10 mmol, 1.1 eq.) keYPhos and the solids outside the glove box were suspended in 20 ml of dry tetrahydrofuran. The mixture was stirred overnight and the yellowish solid was filtered and washed twice with 10 ml of THF each time. The solid was dried under vacuum. 1.7 g (2.52 mmol, 89%) of a yellow-greenish powder were obtained.

Experiment 2: With minor yield losses, it is also possible to stir PdCl₂ overnight in a 1-to-1-solvent mixture of acetonitrile and THF. However, additional purification steps are necessary in order to get the product clean.

Experiment 3 It is also possible to react the palladium complex mechanochemically without solvent addition in a mixture of ligand and PdCl₂.

### Example 3

Synthesis of trYPhos.PdCl₂

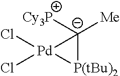

trYPhos (1.00 g, 2.20 mmol, 1.05 eq.) and (COD) PdCl₂ (600 mg, 2.10 mmol, 1.00 eq.) were suspended in dry THF (25 ml) under inert gas; the reaction solution turned dark yellow. After stirring overnight, the solid was allowed to settle and the solution was removed using a filter cannula. The remaining solid was washed twice in each case with both 25 ml of THF and 25 ml of pentane. The solid was dried under vacuum to give the product as a yellow-brownish solid (1.01 g, 1.60 mmol, 76%). IR: \tilde{v}=2927 (m), 2847 (m), 1640 (s), 1581 (s),1332 (m), 1190 (m), 897 (w), 881 (s), 760 (s), 697 (s), 562 (w), 553 (m), 524 (s), 508 (w) cm−1.

¹H NMR (400 MHZ, CD₂Cl₂) δ=1.22-1.45 (m, 9H, CH₂, _{Cy, H3+H4}), 1.61 (d, ³J_{HP}=16.7 Hz, 9H, CH₃, _{tBu}), 1.74 (d, ³J_{HP}=15.7 Hz, 9H, CH₃, _{tBu}), 1.66-1.91 (m, 6H, CH₂, _{Cy, H2+H4}), 1.90-2.01 (m, 6H, CH2, _{Cy, H3}), 2.06 (dd, ³J_{HP}=15.0 Hz, ³J_{HP}=12.8 Hz, 3H, CH₃, _{Me}), 2.31-2.54 (m, 6H, CH₂, _{Cy, H1+H2}), 2.87 (s, 3H, CH₂, _{Cy, H2}).

¹³C{¹H} NMR (101 MHZ, CD₂Cl₂): δ=20.0 (dd, ¹J_{CP}=30.2 Hz, ¹J_{CP}=12.7 Hz, P—C⁻—P), 24.9 (s, CH₃, _{Me}), 25.6 (s, CH₂, _{PCy3, C4}), 27.5 (d, ²J_{CP}=11.6 Hz, CH₂, _{PCy3, C2}), 27.6 (d, ²J_{CP}=11.3 Hz, CH₂, _{PCy3, C2}), 29.2 (s, CH₂, _{PCy3, C3}), 30.3 (d, ³J_{CP}=3.4 Hz, CH₂, _{PCy3, C3}), 31.4 (d, ²J_{CP}=4.2 Hz, CH₃, _{tBu}), 33.2 (d, ²J_{CP}=2.4 Hz, CH₃, _{tBu}), 39.1-40.2 (m, CH, _{PCy3, C1}), 40.1 (d, ¹J_{CP}=2.9 Hz, C, _{tBu}), 41.3 (d, ¹J_{CP}=13.1 Hz, C, _{tBu}) ppm.

³¹P{^{1}} NMR (162 MHZ, CD₂Cl₂): δ=38.7 (d, ²J_{PP}=4.7 Hz, PCy2), 83.2 (d, ²J_{PP}=4.7 Hz, PCy3), ppm.

CHNS: Calculated: C: 53.33, H: 8.57. Measured: C: 53.24, H: 8.73.

IR: \tilde{v}=2933 (s), 2850 (m), 1489 (w), 1447 (m), 1396 (m), 1370 (m), 1325 (w), 1296 (w), 1172 (s), 1124 (w), 1004 (m), 918 (w), 893 (m), 849 (m), 814 (vs), 802 (vs), 747 (w), 619 (m), 596 (w), 541 (m), 508 (m) cm⁻¹.

### Example 4

Synthesis of pinkYPhos.PdCl₂

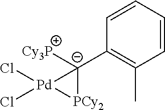

pinkYPhos (1.0 g, 1.72 mmol, 1.1 eq.) and Pd (CH₃CN)₂Cl₂ (0.4 g, 1.56 mmol, 1.0 eq.) were suspended in THF (30 ml) under inert gas and the orange suspension was stirred for 72 h. The resulting yellow suspension was filtered with an inert gas frit and washed twice with 20 ml of THF in each case. The solid was dried under vacuum and the product was obtained as a yellowish solid (0.9 g, 1.18 mmol, 76%).

¹H NMR (400 MHZ, CD₂Cl₂) δ=0.46-2.41 (m, 50H, CH +CH₂, _{PCy3+PCy2}), 2.48 (s, 3H, CH₃), 2.55-3.87 (m, 5H, CH+CH₂, _{PCy3+PCy2}), 7.00-7.14 (m, 1H), 7.14-7.32 (m, 2H), 8.62-9.27 (m, 1H, CH, _{Ar, ortho}) ppm. ³¹P{¹} NMR (162 MHZ, CD₂Cl₂): δ=38.2 (d, ²J_{PP}=5.7 Hz, PCy₂), 57.4 (PCy₃) (isomer: 40.0 (PCy₂), 51.8 (PCY₃)). Due to isomers, the signals in the ¹³C{¹H}-NMR could not be evaluated.

CHNS: Calculated: C: 60.03, H: 8.20. Measured: C: 60.04, H: 8.27.

IR: \tilde{v}=2932 (s), 2917 (vs), 2853 (m), 1445 (m), 1174 (w), 1005 (w), 964 (w), 933 (w), 893 (w), 865 (w), 854 (w), 773 (w), 756 (w), 732 (w), 550 (w), 530 8w), 516 (w) cm⁻¹.

### Example 5

Synthesis of oxYPhos.PdCl₂

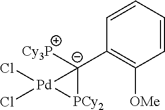

oxYPhos (550 mg, 0.92 mmol, 1.0 eq.) and Pd (CH₃CN)₂Cl₂ (239 mg, 0.92 mmol, 1.0 eq.) is suspended in 10 ml of dry THF under inert gas. The yellowish suspension was stirred overnight. The solid was filtered off and washed with 10 ml of THF. The solid was dried under vacuum and the product was obtained as a dark-yellow solid (477 mg, 0.62 mmol, 67%).

¹H NMR (400 MHZ, CD₂Cl₂) δ=0.77-3.48 (m, 55H, CH, _{PCy3+PCy2}+CH₂, _{PCy3+PCy2}), 3.81 (s, 3H, OCH₃), 6.76 (d, J=8.2 Hz, 1H, CH, _{Ar, meta}), 7.01 (t, J=7.6 Hz, 1H, CH, _{Ar, meta}), 7.32 (td, J=7.8, 1.8 Hz, 1H, CH, _{Ar, para}), 8.86 (d, ³J_{HH}=7.7 Hz, 1H, CH, _{Ar, ortho}) ppm.

¹³C{¹H} NMR (101 MHZ, CD₂Cl₂): δ=25.8-26.1 (m, CH, CH₂, _{PCy3, C4}), 26.1-26.3 (m, CH₂, _{PCy3, C3}), 27.4-28.0 (m, CH₂, _{PCy3, C2+C3+PCy2, C3}), 28.1 (d, ³J_{CP}=16.1 Hz, CH₂, _{PCy2, C3}), 29.1-31.5 (vbr, CH₂, _{PCy3, C2}) 30.6 (CH₂, _{PCy2, C2}), 30.8 (d, ²J_{CP}=7.5 Hz, CH₂, _{PCy2, C2}), 31.2 (d, ²J_{CP}=2.4 Hz, CH₂, _{PCy2, C2}), 32.1 (CH₂, _{PCy2, C2}), 36.8-39.2 (vbr, CH, _{PCy2, C1}), 39.5 (d, ¹J_{PP}=15.5 Hz, CH, _{PCy2, C1}), 39.6 (d, ¹J_{PP}=21.5 Hz, CH, _{PCy2, C1}), 55.5 (s, OCH₃), 109.9 (CH, _{Ar, meta}), 122.2 (CH, _{Ar, ipso}), 122.3 (CH, _{Ar, meta}), 130.7 (CH, _{Ar, para}), 142.5 (CH, _{Ar, ortho}), 158.5 (CH, _{Ar, ortho}) ppm.

³¹P{¹H} NMR (162 MHZ, CD₂Cl₂): δ=36.4 (d, ²J_{PP}=7.6 Hz, PCy₃), 54.1 (PCy₂) ppm.

IR: \tilde{v}=2980 (m), 2971 (m), 2945 (m), 2915 (vs), 2868 (w), 2848 (s), 1478 (w), 1467 (w), 1443 (m), 1429 (w), 1238 (vs), 1210 (w), 1171 (w), 1115 (w), 1034 (w), 1007 (m), 979 (s), 900 (s), 884 (m), 847 (m), 745 (s), 736 (m), 542 (m), 516 (w) cm⁻¹.

### Example 6

Isolation of joYPhos.PdCl₂

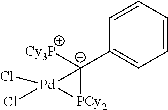

joYPhos (1.00 g, 1.76 mmol, 1.10 eq.) and Pd (CH₃CN)₂Cl₂ (0.42 g, 1.60 mmol, 1.00 eq.) were suspended in dry THF (50 ml) under inert gas. The orange suspension was stirred for 48 h, and the crude product was filtered via an inert gas frit and washed with 40 ml of THF. The yellow solid was dried under vacuum and the product was isolated as a yellowish powder (1.04 g, 1.39 mmol, 87%).

¹H NMR (400 MHZ, CD₂Cl₂) δ=0.60-2.88 (m, 55H, CH, _{PCy3+PCy2}+CH₂, _{PCy3+PCy2}), 7.12 (d, ³J_{HH}=7.9 Hz, 1H, CH, ₒᵣₜₕₒ), 7.22 (t, ³J_{HH}=7.5 Hz, 1H, CH, ₘₑₜₐ), 7.32 (t, ³J_{HH}=7.4 Hz, 1H, CH, ₚₐᵣₐ), 7.40 (t, ³J_{HH}=7.7 Hz, 1H, CH, ₘₑₜₐ), 8.91 (d, ³J_{HH}=7.7 Hz, 1H, CH, ₒᵣₜₕₒ) ppm.

¹³C{^{1}} NMR (101 MHZ, CD₂Cl₂): δ=26.1 (S, CH₂, _{PCy2, C4+PCy3, C4}), 27.4 (d, ³J_{CP}=11.6 Hz, CH₂, _{PCy3, C3}), 27.7 (d, ³J_{CP}=12.1 Hz, CH₂, _{PCy2, C3}), 28.0 (s, CH₂, _{PCy2, C3}), 28.1 (d, ³J_{CP}=23.6 Hz, CH₂, _{PCy2, C3}), 28.5 (d, ²J_{CP}=16.5 Hz, CH₂, _{PCy2, C2}), 30.8 (s, CH₂, _{PCy2, C3}), 32.0 (d, ²J_{CP}=8.0 Hz, CH₂, _{PCy2, C2}), 32.3-32.1 (m, CH₂, _{PCy2, C2}), 39.8 (d, ¹J_{CP}=21.8 Hz, CH, _{PCy2, C1}), 41.0 (d, ¹J_{CP}=13.0 Hz, CH, _{PCy2, C1}), 127.7 (s, CH, _{Ph, meta}), 129.0 (s, CH, _{Ph, para}), 130.3 (s, CH, _{Ph, meta}), 132.4 (s, CH, _{Ph, ortho}), 133.9 (s, CH, _{Ph, ipso}), 141.2 (t, ³J_{CP}=5.2 Hz, CH, _{Ph, ortho}).

³¹P{¹H} NMR (162 MHZ, CD₂Cl₂): δ=35.3 (d, ²J_{PP}=3.9 Hz, PCy₃), 53.7 (d, ²J_{PP}=4.0 Hz, PCy₂) ppm.

CHNS: Calculated: C: 59.72, H: 8.13. Measured: C: 60.08, H: 8.10.

IR: \tilde{v}=2918 (vs), 2851 (s), 1446 (s), 1174 (m), 1000 (s), 950 (m), 918 (m), 892 (w), 857 8m), 851 (m), 707 (s), 538 (s), 529 (s), 512 (m) cm⁻¹.

### Example 7

Isolation of joYPhos.PdBr₂

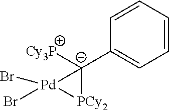

joYPhos (500 mg, 0.88 mmol, 1.1 eq.) and (cod) PdBr₂ (300 mg, 0.80 mmol, 1.0 eq.) was suspended in THF (25 ml). The orange suspension was stirred overnight and the crude product was filtered via a Schlenk frit. The solid was washed twice with 10 ml of THF and dried under vacuum. The product was obtained as a yellowish powder. (550 mg, 0.66 mmol, 82%).

¹H NMR (400 MHZ, CD₂Cl₂) δ=0.56-3.16 (m, 55H, CH, _{PCy3+PCy2}+CH₂, _{PCy3+PCy2}), 7.15 (d, ³J_{HH}=7.9 Hz, 1H, CH, ₒᵣₜₕₒ), 7.23 (t, ³J_{HH}=7.5 Hz, 1H, CH, ₘₑₜₐ), 7.33 (t, ³J_{HH}=7.4 Hz, 1H, CH, para), 7.40 (t, ³J_{HH}=7.7 Hz, 1H, CH, ₘₑₜₐ), 8.96 (d, ³J_{HH}=7.7 Hz, 1H, CH, ₒᵣₜₕₒ) ppm.

¹³C{¹H} NMR (101 MHZ, CD₂Cl₂): δ=25.8-26.1 (m, CH₂, _{PCy2, C4+PCy3, C4}), 27.1-27.4 (m, CH₂, _{PCy3, C3}), 27.6 (d, ³J_{CP}=12.3 Hz, CH₂, _{PCy2, C3}), 27.9 (d, ³J_{CP}=4.9 Hz, CH₂, _{PCy2, C3}), 28.0 (CH₂, _{PCy2, C3}), 28.3 (d, ²J_{CP}=16.4 Hz, CH₂, _{PCy2, C3}), 30.9 (CH₂, _{PCy2, C2}), 32.08 (d, ²J_{CP}=13.6 Hz, CH₂, _{PCy2, C2}), 32.09 (CH₂, _{PCy2, C2}), 32.4 (d, ²J_{CP}=2.9 Hz, CH₂, _{PCy2, C2}), 40.0 (d, ¹J_{CP}=21.7 Hz, CH, _{PCy2, C1}), 41.3 (d, ¹J_{CP}=13.0 Hz, CH, _{PCy2, C1}), 127.6 (t, ⁴J_{CP}=2.1 Hz, CH, _{Ph, meta}), 128.9 (t, ⁵J_{CP}=2.5 Hz, CH, _{Ph, para}), 130.2 (CH, _{Ph, meta}), 132.5 (t, ³J_{CP}=3.8 Hz, CH, _{Ph, ortho}), 133.5 (CH, _{Ph, ipso}), 141.7 (t, ³J_{CP}=5.1 Hz, CH, _{Ph, ortho}).

³¹P{¹H} NMR (162 MHZ, CD₂Cl₂): δ=35.2 (d, ²J_{PP}=3.9 Hz, PCy₃), 59.2 (d, ²J_{PP}=3.9 Hz, PCy₂) ppm.

### Example 8

Isolation of joYPhos.HPdCl₃

joYPhos.HPdCl₃ can be synthesized both from joYPhos.H and from joYPhos.PdCl₂:

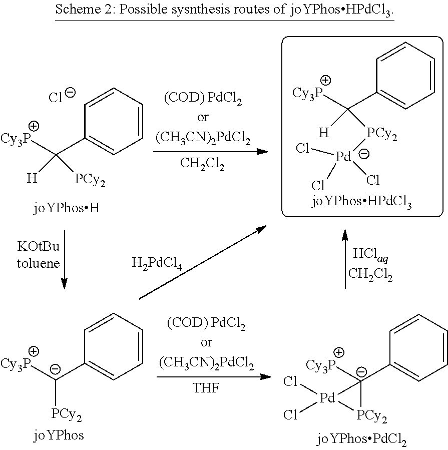

In the following, the synthesis route starting from joyPhos.PdCl₂ will be described.

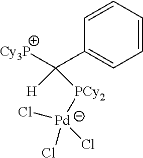

joyPhos.PdCl₂ (0.2 g, 0.27 mmol, 1.0 eq.) was suspended in dry dichloromethane (10 ml) and mixed with concentrated hydrochloric acid (0.1 ml, 37% in water, 1.35 mmol, 5.0 eq.). The orange solution was stirred overnight and the solvent was removed under vacuum. Dry THF (20 ml) was added and the mixture was stirred for one hour. The precipitated solid was filtered via a Schlenk frit and washed with dry THF (10 ml). The solid was dried under vacuum and the product was obtained as a yellowish powder. (130 mg, 0.17 mmol, 62%).

¹H NMR (400 MHZ, CD₂Cl₂) δ=−0.12-0.24 (m, 1H, CH₂, _{PCy2, H3}), 0.96-2.01 (m, 45H, CH₂, _{PCy3+PCy2}), 2.03-2.32 (m, 7H, CH₂, _{PCy3, H2+PCy2, H2}), 2.33-2.52 (m, 1H, CH, _{PCy2, H1}), 2.63-2.75 (m, 1H, CH, _{PCy2, H1}), 2.75-2.84 (m, 1H, CH₂, _{PCy2, H2}), 3.06-3.17 (m, 1H, CH₂, _{PCy2, H2}), 3.21-4.67 (m, 2H, CH, _{PCy3, H1}), 4.39 (dd, 1H, ¹J_{CP}=15.6 Hz, ³J_{CP}=12.3 Hz, CH, _{PCy3, H1}), 7.22 (d, 1H, ⁴J_{CP}=7.7 Hz, CH, ₒᵣₜₕₒ), 7.37 (t, 1H, ⁵J_{CP}=7.6 Hz, CH, ₘₑₜₐ), 7.45 (t, 1H, ⁶J_{CP}=7.5 Hz, CH, ₚₐᵣₐ), 7.52 (t, 1H, ⁵J_{CP}=7.6 Hz, CH, ₘₑₜₐ), 8.55 (d, 1H, ⁴J_{CP}=7.9 Hz, CH, ₒᵣₜₕₒ) ppm.

¹³C{¹H} NMR (101 MHZ, CD₂Cl₂): δ=26.3 (d, J=1.8 Hz, CH₂, _{PCy3, C4}), 26.6-27.1 (m, CH₂, _{PCy2, C4+PCy3, C3}), 27.3 (d, ³J_{CP}=11.8 Hz, CH₂, _{PCy3,l C3}), 28.1 (d, ³J_{CP}=15.6 Hz, CH₂, _{PCy2, C3}), 28.26 (d, ³J_{CP}=2.3 Hz, CH₂, _{PCy2, C3}), 28.34 (d, ³J_{CP}=1.9 Hz, CH₂, _{PCy2, C3}), 28.9 (d, ³J_{CP}=16.2 Hz, CH₂, _{PCy2, C3}), 30.5 (d, ²_{CP}=8.7 Hz, CH₂, _{PCy2, C2}), 30.8 (d, ²J_{CP}=4.9 Hz, CH₂, _{PCy3, C2}), 31.4 (CH₂, _{PCy3, C2}), 32.0 (d, ²J_{CP}=8.7 Hz, CH₂, _{PCy2, C2}), 32.8 (d, ²J_{CP}=3.8 Hz, CH₂, _{PCy2, C2}), 34.3 (d, ¹J_{CP}=6.2 Hz, CH₂, _{PCy2, C2}), 34.4-35.1 (m, CH, _{PCy3, C1}), 38.4 (d, ¹J_{CP}=16.5 Hz, CH, _{PCy2, C1}), 41.1 (dd, ¹J_{CP}=17.7 Hz, ³J_{CP}=2.3 Hz, CH, _{PCy2, C1}), 127.4 (dd, ²J_{CP}=5.5 Hz, ⁴J_{CP}=3.8 Hz, CH, _{Ph, ipso}), 129.1 (CH, _{Ph, meta}), 129.5 (d, ⁴J_{CP}=2.5 Hz, CH, _{Ph, meta}), 130.2 (t, ⁵J_{CP}=1.9 Hz, CH, _{Ph, para}), 132.3 (dd, ³J_{CP}=6.7 Hz, ⁵J_{CP}=4.1 Hz, CH, _{Ph, ortho}), 134.0 (d, ³J_{CP}=2.7 Hz, CH, _{Ph, ortho}) ppm.

³¹P{¹H} NMR (162 MHZ, CD₂Cl₂): δ=31.4 (d, ²J_{PP}=14.5 Hz, PCy₃), 38.5 (d, ²J_{PP}=14.5 Hz, PCy₂) ppm.

By adding base (KOtBu), the complex can be converted into the corresponding joYPhos-PdCl₂ complex.

Examples of the synthesis of compounds of formula II from H₂PdX₄, here: acidic aqueous palladium chloride solution/H₂PdCl₄

### Example 8a

joYPhos HPdCl₃: Palladium Chloride Solution Initially Provided

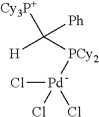

0.47 g of palladium chloride solution (20% Pd; 0.88 mmol; 1.0 eq) was initially provided in 15 mL of degassed acetone; the container was rinsed with 5 mL of acetone. 0.50 g of joYPhos (0.88 mmol; 1.0 eq) was added and the container was rinsed with 5 mL of acetone. After addition, the reaction mixture became lighter. The orange suspension was stirred at room temperature for 4 hours. The light-orange suspension was filtered and the light-yellow solid was washed with 10 ml of acetone. The product was dried under vacuum at 40° C. 0.57 g of yellow amorphous product was obtained (0.73 mmol; 83%). Analytical data correspond to the product from the two-stage synthesis.

### Example 8b

### Ligand Initially Provided

0.50 g of joYPhos (0.88 mmol; 1.0 eq) was initially provided in 15 mL of degassed acetone; the container was rinsed with 5 ml of acetone. 0.47 g of palladium chloride solution (20% Pd; 0.88 mmol; 1.0 eq) was added dropwise and the container was rinsed with 5 mL of acetone. The orange suspension was stirred at room temperature for 4 hours. The light-orange suspension was filtered and the light-yellow solid was washed with 10 mL of acetone. The product was dried under vacuum at 40° C. 0.60 g of yellow amorphous product was obtained (0.77 mmol; 87%). Analytical data correspond to the product from the two-stage synthesis.

### Example 8c

### Solvent is Ethanol Instead of Acetone

0.47 g of palladium chloride solution (20% Pd; 0.88 mmol; 1.0 eq) was initially provided in 15 mL of degassed ethanol; the container was rinsed with 5 mL of ethanol. 0.50 g of joYPhos (0.88 mmol; 1.0 eq) was added and the container was rinsed with 5 mL of ethanol. After addition, the reaction mixture became lighter. The orange suspension was stirred at room temperature for 4 hours. The light-orange suspension was filtered and the light-yellow solid was washed with 10 ml of ethanol. The product was dried under vacuum at 40° C. 0.61 g of yellow amorphous product was obtained (0.78 mmol; 89%). Analytical data correspond to the product from the two-stage synthesis.

### Example 8d

trYPhos HPdCl₃: Palladium Chloride Solution Initially Provided

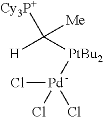

0.59 g of palladium chloride solution (20% Pd; 1.10 mmol; 1.0 eq) was initially provided in 15 ml of degassed acetone; the container was rinsed with 5 mL of acetone. 0.50 g of trYPhos (1.10 mmol; 1.0 eq) was added and the container was rinsed with 5 mL of acetone. After addition, the reaction mixture became lighter. The orange-red suspension was stirred at room temperature for 2 hours. The suspension was filtered and the orange solid was washed with 10 mL of acetone. The product was dried under vacuum at 40° C. 0.42 g of light-red amorphous product was obtained (0.63 mmol; 57.29%). Analytical data correspond to the product from the two-stage synthesis.

### Example 8e

### Ligand Initially Provided

0.50 g of trYPhos (1.10 mmol; 1.0 eq) was initially provided in 10 mL of degassed acetone; the container was rinsed with 5 ml of acetone. 0.59 g of palladium chloride solution (20% Pd; 1.10 mmol; 1.0 eq) was filled with 5 mL of acetone into a dropping funnel and slowly added dropwise. The dropping funnel was rinsed with 5 ml of acetone. After addition, the reaction mixture became lighter. The orange-red suspension was stirred at room temperature for 2 hours. The suspension was filtered and the orange solid was washed with 10 ml of acetone. The product was dried under vacuum at 40° C. 0.42 g of light-red amorphous product was obtained (0.63 mmol; 57.29%). Analytical data correspond to the product from the two-stage synthesis.

### Example 8f

keYPhos HPdCl₃: Palladium Chloride Solution Initially Provided

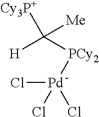

### MIE21040:

0.59 g of palladium chloride solution (20% Pd; 1.10 mmol; 1.0 eq) was initially provided in 15 mL of degassed acetone; the container was rinsed with 5 mL of acetone. 0.50 g of trYPhos (1.10 mmol; 1.0 eq) was added and the container was rinsed with 5 mL of acetone. After addition, the reaction mixture became lighter. The orange suspension was stirred at room temperature for 2 hours. The suspension was filtered and the light-orange solid was washed with 10 ml of acetone. The product was dried under vacuum at 40° C. 0.54 g of light-orange amorphous product was obtained (0.75 mmol; 76%). Analytical data correspond to the product from the two-stage synthesis.

### Application in Catalysis

### Buchwald-Hartwig Amination—General Procedure

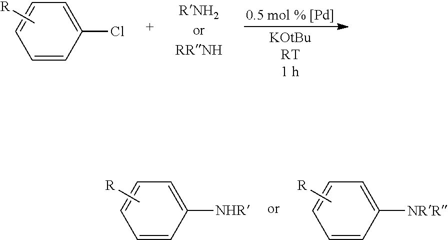

In the glove box, a 6-ml vessel was filled with the precatalyst (0.005 mmol, 0.005 eq.) and with potassium tert-butanolate (1.5 mmol, 1.5 eq.), and was closed with a septum cap. The vessel was removed from the glove box and a further vessel was prepared with a measurement solution. To this end, 1.0 mmol (1.0 eq.) of a haloaryl was loaded with 1.1 mmol (1.1 eq.) of a primary or secondary amine and the GC-standard tetradecane (1.0 mmol, 1.0 eq.), and dry THF was filled up to a volume of 3 ml. [Only for L.PdCl₂ complexes: The vessel with precatalyst was initially loaded with 0.61 μl (0.005 mmol, 0.005 eq.) of 1,5-cyclooctadiene in 1 ml of dry THF and the mixture was stirred for 5 minutes.] The measurement solution was added to the catalyst mixture and the catalytic reaction was stirred for 1 hour at room temperature.]

After one hour, the reaction was quenched with a saturated NaCl solution, a drop of the organic phase was rinsed with ethyl acetate via a filter pipette filled with silica gel, and a GC-FID spectrum was measured from the sample. The product signal was compared with the standard by including a response factor in the calculation.

The isolated YPhos-PdX₂ complexes (X=Cl, Br, or I) were used as precatalysts. These were compared with other precatalysts. For this purpose, the respective YPhos ligand with Pd₂dba₃.dba, [Pd(allyl)Cl]₂, [Pd(cinnamyl)Cl]₂ or [Pd(tert-butyl-indenyl)Cl]₂ in a 1:1 ratio was used

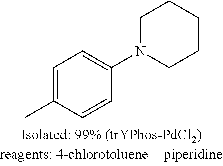

### Example 9

| | keYPhos | trYPhos | joYPhos | pinkYPhos |
|---|---|---|---|---|
| L + Pd₂dba₃•dba | >99% | 12% | 93% | 71% |
| L•Pd(allyl)Cl | >99% | >99% | >99% | 77% |
| L•Pd(cinnamyl)Cl | >99% | >99% | >99% | >99% |
| L•Pd(1-tBu-indenyl)Cl | >99% | | >99% | >99% |
| L•PdCl₂⁽¹⁾ | 96% | 99% | >99% | 62% |
| L•HPdCl₃ | 91%⁽²⁾ | 55% | 31% | 2% |

⁽¹⁾Addition of 0.5 mol % of cyclooctadiene

Scheme 4: Comparison of various catalysts in the Buchwald-Hartwig amination of 4-chlorotoluene and piperidine.

### Example 10

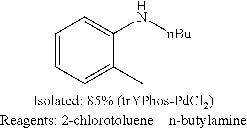

| | | trYPhos | joYPhos | joYPhos | | |
|---|---|---|---|---|---|---|
| | keYPhos | 0.5 mol % | 0.1 mol % | 0.05 mol % | joYPhos | pinkYPhos |
| L + Pd₂dba₃•dba | >99% | 53% | 97% | 38% | 9% | 82% |
| L•Pd(allyl)Cl | >99% | 82% | >99% | 81% | 51% | >99% |
| L•Pd(cinnamyl)Cl | 99% | >99% | >99% | 91% | 37% | >99% |
| L•Pd(1-tBu-indenyl)Cl | >99% | | 99% | 85% | 52% | >99% |
| L•PdCl₂ ⁽¹⁾ | 98% | 99% | >99% | 79% | 46% | >99% |
| L HPdCl₃ | 92%⁽¹⁾ | 91%⁽²⁾ | 91%⁽²⁾ | | | 4%⁽²⁾ |

Scheme 5: Comparison of various catalysts in the Buchwald-Hartwig amination of 2-chlorotoluene and n-butylamine; (above) 0.5 mol % of loading, comparison of different YPhos ligands and Pd sources;

### Example 11

Comparison of joYPhos With Different Pd Sources at 0.1 and 0.05 mol %

| | | |
|---|---|---|
| 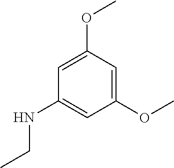 | Reagents: 5-chloro-1,3- dimethoxybenzene + ethylamine Reaction time: 20 h keYPhos•PdCl₂ trYPhos•PdCl₂ joYPhos•PdCl₂ pinkYPhos•PdCl₂ oxYPhos•PdCl₂ Literature comparison YPhos^{[2]} (mesYPhos + Pd₂dba₃•Pddba) (2:1) | 42% 77% 70% 88% 84% 83% |
| Isolated: 79% | | |
| (pinkYPhos•PdCl₂) | | |
| 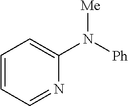 [SMILES: CN(c1ccccc1)c1ccccn1] | Reagents: 2-chloropyridine + N-methylaniline keYPhos•PdCl₂ trYPhos•PdCl₂ joYPhos•PdCl₂ pinkYPhos•PdCl₂ oxYPhos•PdCl₂ | 83% 21% 33% 30% 25% |
| Isolated: 79% | | |
| (keYPhos•PdCl₂) | | |

### Results Without Addition of Cyclooctadiene

In our experiments, we found that the addition of 1,5-cyclooctadiene in equimolar amounts to the precatalyst provides for better reaction conversions. While a diene is present during the reaction in the case of already known allyl, cinnamyl, indenyl or dibenzylideneacetone complexes, no diene is present within the catalysis in the case of complexes mentioned here. The good coordination properties of 1,5-cyclooctadiene result in better catalysis results. All results without addition of 1,5-cyclooctadiene are listed below.

| | | |
|---|---|---|
| 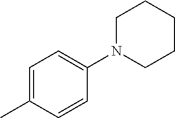 | Reagents: 4-chlorotoluene + piperidine keYPhos•PdCl₂ trYPhos•PdCl₂ joYPhos•PdCl₂ pinkYPhos•PdCl₂ | 95% >99% 72% 71% |
| 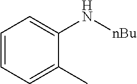 | Reagents: 2-chlorotoluene + n-butylamine keYPhos•PdCl₂ trYPhos•PdCl₂ joYPhos•PdCl₂ pinkYPhos•PdCl₂ | >99% >99% >99% >99% |
| | oxYPhos•PdCl₂ | >99% |
| 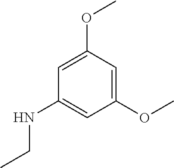 | Reagents: 5-chloro-1,3- dimethoxybenzene + ethylamine Reaction time: 20 h keYPhos•PdCl₂ trYPhos•PdCl₂ joYPhos•PdCl₂ pinkYPhos•PdCl₂ oxYPhos•PdCl₂ | 10% 52% 66% 71% 70% |
| 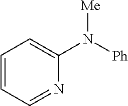 [SMILES: CN(c1ccccc1)c1ccccn1] | Reagents: 2-chloropyridine + N- methylaniline keYPho•PdCl₂ trYPhos•PdCl₂ joYPhos•PdCl₂ pinkYPhos•PdCl₂ oxYPhos•PdCl₂ | 88% 61% 52% 41% 12% |

### α-Arylation of Ketones—General Procedure

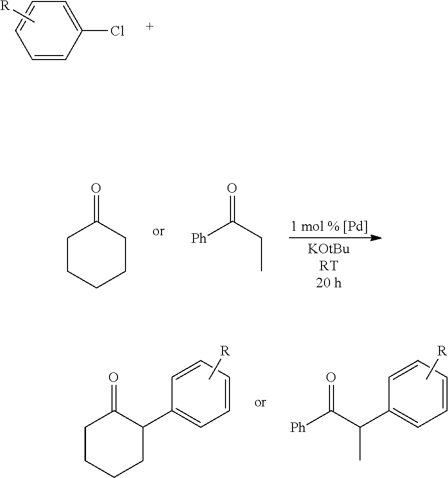

In the glove box, a 6-ml vessel was filled with the precatalyst (0.01 mmol, 0.01 eq.) and closed with a septum cap. Another vessel was filled in the glove box with potassium tert-butanolate (1.5 mmol, 1.5 eq.) and both vessels were removed from the glove box. The base was first dissolved in 4 ml of dry THF, then 1.1 mmol (1.1 eq.) of cyclohexanone or ethyl phenyl ketone were added and the mixture was stirred for 30 minutes. The following were added to the mixture in the following order: tetradecane (1.0 mmol, 1.0 eq.) and the corresponding haloaryl (1.0 mmol, 1.0 eq.). The solution was transferred to the dry precatalyst in the other vessel and the catalysis reaction was performed with stirring for 20 hours (cyclohexanone: 60° C., ethyl phenyl ketone: room temperature).

After one hour, the reaction was quenched with a saturated NaCl solution, a drop of the organic phase was rinsed with ethyl acetate via a filter pipette filled with silica gel, and a GC-FID spectrum was measured from the sample. The product signal was compared with the standard by including a response factor in the calculation.

### Example 12

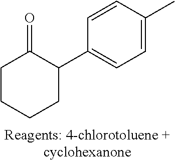

| | | keYPhos | trYPhos | joYPhos | pinkYPhos |
|---|---|---|---|---|---|
| Execution | L + Pd₂dba₃•dba | 0% | 1% | 5% | 16% |
| at room | L•Pd(allyl)Cl | 7% | 0% | 1% | 22% |
| temperature: | L•Pd(cinnamyl)Cl | 0% | 0% | 18% | 36% |
| | L•Pd(1-tBu-indenyl)Cl | 8% | | 14% | 52% |
| | L•PdCl₂ | 4% | 3% | 18% | 50% |
| | L•HPdCl₃ | 10% | 0% | 7% | 6% |

| | | keYPhos | trYPhos | joYPhos | pinkYPhos |
|---|---|---|---|---|---|
| Execution at | L + Pd₂dba₃•dba | 51% | 3% | 52% | 43% |
| 60° C.: | L•Pd(allyl)Cl | 80% | 42% | 64% | 79% |
| | L•Pd(cinnamyl)Cl | 56% | 3% | 63% | 68% |
| | L•Pd(1-tBu-indenyl)Cl | 69% | | 50% | 56% |
| | L•PdCl₂ | 77% | 6% | 36% | 76% |
| | L•HPdCl₃ | 53% | 4% | 25% | 11% |

Scheme 6: Comparison of various catalysts in the α-arylation of 4-chlorotoluene and cyclohexanone at room temperature and 60° C.

### Example 13

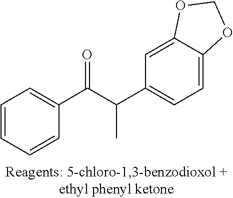 [SMILES: CC(C(=O)c1ccccc1)c1ccc2c(c1)OCO2]

| | keYPhos | trYPhos | joYPhos | pinkYPhos |
|---|---|---|---|---|
| L + Pd₂dba₃•dba | 98% | 1% | 19% | 1% |
| L•Pd(allyl) Cl | >99% | 1% | 28% | 0% |
| L•Pd(cinnamyl)Cl | >99% | 0% | 66% | 7% |
| L•Pd(1-tBu-indenyl)Cl | >99% | | 41% | 6% |
| L•PdCl₂ | >99% | 1% | 10% | 5% |
| L•HPdCl₃ | 73% | 0% | 29% | 0% |

Scheme 7: Comparison of various catalysts in the a-arylation of 1,3-benzodioxol and ethyl phenyl ketone at room temperature.

### Example 14

| | | |
|---|---|---|
| 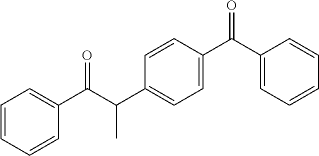 [SMILES: CC(C(=O)c1ccccc1)c1ccc(C(=O)c2ccccc2)cc1] | Reagents: 4-chlorobenzophenone + ethyl phenyl ketone keYPhos•PdCl₂ trYPhos•PdCl₂ joYPhos•PdCl₂ pinkYPhos•PdCl₂ oxYPhos•PdCl₂ | 95% 31% 73% 13% 86% |

Note: Addition of 1,5-cyclooctadiene resulted in a deterioration of the results, and this addition was therefore dispensed with.

### Feringa Coupling—General Procedure

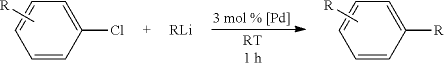

In the glove box, a 6-ml vessel was filled with the precatalyst (0.03 mmol, 0.03 eq.) and closed with a septum cap. The vessel was removed from the glove box and a mixture of haloaryl (1.00 mmol, 1.00 eq.), tetradecane (1.00 mmol, 1.00 eq.) in 1 ml of dry toluene was added. The organolithium compound (1.2 mmol, diluted with dry toluene to 3.3 ml with a concentration of 0.36 M, 1.2 eq.) was added to the reaction solution via a syringe pump within one hour. The black suspension was quenched with a saturated NaCl solution, a drop of the organic phase was rinsed with ethyl acetate via a filter pipette filled with silica gel, and a GC-FID spectrum was measured from the sample. The product signal was compared with the standard by including a response factor in the calculation.

### Example 15

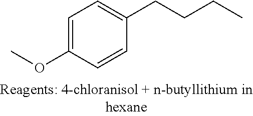

| | keYPhos | trYPhos | joYPhos | pinkYPhos | |
|---|---|---|---|---|---|
| L + Pd₂dba₃•dba | 73% | 95% | 74% | 89% | Throughput |
| | (88%) | (81%) | (89%) | (87%) | (product |
| L•Pd(allyl)Cl | 50% | 64% | 49% | 98% | content) |
| | (79%) | (73%) | (83%) | (91%) | |
| L•Pd(cinnamyl)Cl | 40% | 72% | 81% | 99% | |
| | (82%) | (72%) | (88%) | (92%) | |
| L•Pd(1-tBu-indenyl)Cl | 42% | | 92% | 93% | |
| | (78%) | | (88%) | (87%) | |
| L-PdCl₂ | 38% | 55% | 84% | 91% | |
| | (83%) | (69%) | (88%) | (87%) | |

Scheme 8: Comparison of various catalysts in the alkylation of 4-chloroanisole with n-butyllithium.

### Example 16

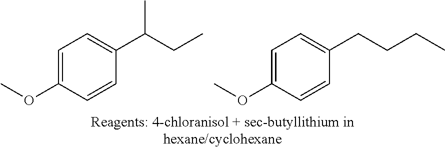

| | keYPhos | trYPhos | joYPhos | pinkYPhos | |
|---|---|---|---|---|---|
| L + Pd₂dba₃•dba | 49% | 90% | 95% | 90% | Throughput |
| | (73%) | (64%) | (85%) | (75%) | (product |
| | [83:17] | [97:3] | [97:3] | [96:4] | content) |
| L•Pd(allyl)Cl | 71% | 43% | 52% | 47% | [ratio of |
| | (79%) | (69%) | (81%) | (75%) | branched |
| | [84:16] | [97:3] | [96:4] | [97:3] | product: |
| L•Pd(cinnamyl)Cl | 69% | 61% | 87% | 96% | linear |
| | (77%) | (47%) | (85%) | (74%) | product] |
| | [83:17] | [97:3] | [96:4] | [97:3] | |
| L•Pd(1-tBu-indenyl)Cl | 85% | | 96% | 87% | |
| | (77%) | | (82%) | (76%) | |
| | [84:16] | | [96:4] | [96:4] | |
| L•PdCl₂ | 38% | 82% | 92% | 94% | |
| | (62%) | (63%) | (78%) | (78%) | |
| | [83:17] | [97:3] | [96:4] | [97:3] | |

Scheme 9: Comparison of various catalysts in the alkylation of 4-chloroanisole with sec-butyllithium.

### Example 17

| | | |
|---|---|---|
| 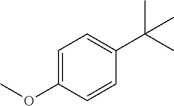 | Reagents: 4-chloranisol + tert-butylithium in pentane (ratio of branched product:linear product) keYPhos•PdCl₂ trYPhos•PdCl₂ joYPhos•PdCl₂ | 65% (0:100) 7% (0:100) 52% |
| | | (0:100) |
| 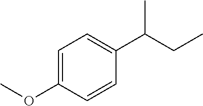 | pinkYPhos•PdCl₂ oxYPhos•PdCl₂ Literature comparison YPhos^{[4]} (joYPhos + Pd₂dba₃•Pddba) | 49% (0:100) 65% (0:100) 64% (0:100) |

### Kumada Coupling—General Procedure

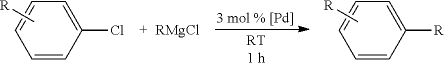

In the glove box, a 6-ml vessel was filled with the precatalyst (0.03 mmol, 0.03 eq.) and closed with a septum cap. The vessel was removed from the glove box and a mixture of haloaryl (1.00 mmol, 1.00 eq.), tetradecane (1.00 mmol, 1.00 eq.) in 1 ml of dry toluene was added. The Grignard compound (1.2 mmol, diluted with dry toluene to 3.3 ml with a concentration of 0.36 M, 1.2 eq.) was added to the reaction solution via a syringe pump within one hour. The black suspension was quenched with a saturated NaCl solution, a drop of the organic phase was rinsed with ethyl acetate via a filter pipette filled with silica gel, and a GC-FID spectrum was measured from the sample. The product signal was compared with the standard by including a response factor in the calculation.

### Example 18

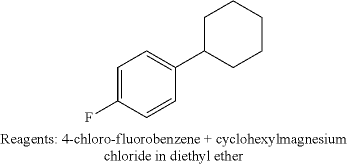 [SMILES: Fc1ccc(C2CCCCC2)cc1]

| | keYPhos | keYPhos | | | |
|---|---|---|---|---|---|
| | 3.0 mol % | 0.5 mol % | trYPhos | joYPhos | pinkYPhos |
| L + Pd₂dba₃•dba | >99% | >99% | 46% | 99% | 97% |
| L•Pd(allyl)Cl | 97% | 25% | 11% | 80% | 85% |
| L•Pd(cinnamyl)Cl | 96% | 96% | 42% | 95% | >99% |
| L•Pd(1-tBu-indenyl)Cl | >99% | >99% | | 93% | 92% |
| L•PdCl₂ | >99% | >99% | 42% | 94% | 96% |

Scheme 10: Comparison of various catalysts in the alkylation of 4-chlorofluorobenzene with cyclohexylmagnesium chloride. 3 mol % loading, comparison of various YPhos ligands and Pd sources; comparison of keYPhos with different Pd sources at 0.5 mol % loading.

### Example 19

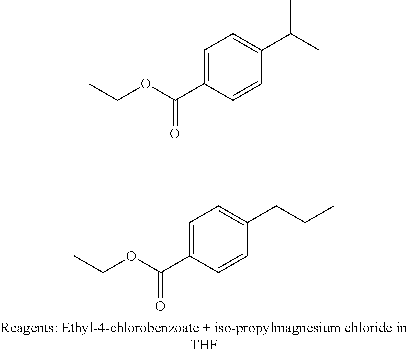

| | keYPhos | trYPhos | joYPhos | pinkYPhos | |
|---|---|---|---|---|---|
| L + Pd₂dba₃•dba | 76% | 87% | 90% | 90% | Product content |
| | [73:27] | [96:4] | [90:10] | [93:7] | [ratio of |
| L•Pd(allyl)Cl | 78% | 91% | 87% | 93% | branched |
| | [74:26] | [98:2] | [91:9] | [94:6] | product: |
| L•Pd(cinnamyl)Cl | 32% | 87% | 91% | 96% | linear |
| | [78:22] | [97:3] | [93:7] | [97:3] | product] |
| L•Pd(1-tBu-indenyl)Cl | 77% | | 88% | 86% | |
| | [74:26] | | [92:8] | [96:4] | |
| L•PdCl₂ | 70% | 76% | 81% | 86% | |
| | [74:26] | [97:3] | [92:8] | [98:2] | |

Scheme 11: Comparison of various catalysts in the alkylation of ethyl-4-chlorobenzoate with iso-propylmagnesium chloride.

1. A compound of formula I or II 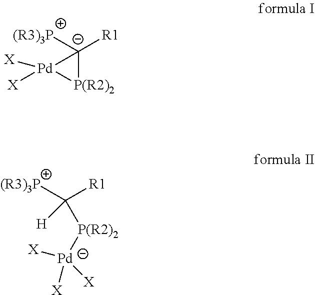
wherein X is halogen, R1 is alkyl, perfluoroalkyl, aryl or cycloalkyl, in each case substituted or unsubstituted, cyano, sulfonyl —SO2—R10 with R10=C1-C5 alkyl, C5-C6 cycloalkyl, C5-C10 aryl, in each case unsubstituted or substituted with C1 to C4 alkyl or C1 to C4 perfluoroalkyl, silyl —Si(R20R30R40) with R20, R30 and R40, which each independently of one another are C1-C6 alkyl or C5-C10 aryl, in each case unsubstituted or substituted with C1 to C4 alkyl,
R2 is alkyl or cycloalkyl, adamantyl and aryl, and
R3 is alkyl, cycloalkyl and aryl.

2. A compound according to claim 1, wherein X is chlorine, bromine, iodine or combinations thereof.

3. A compound according to claim 1, wherein R1 is C1 to C9 alkyl, C4-C8 cycloalkyl, cyano, sulfonyl —SO2—R10 with R10=C1-C5 alkyl, C5-C6 cycloalkyl, C5-C10 aryl, in each case unsubstituted or substituted with C1 to C4 alkyl, C1 to C4 alkoxy or C1 to C4 perfluoroalkyl, silyl —Si(R20R30R40) with R20, R30 and R40, which each independently of one another are C1-C6 alkyl or C5-C10 aryl, in each case unsubstituted or substituted with C1 to C4 alkyl, or R1 is C5-C10 aryl which may be mono-or polysubstituted with C1 to C5 alkyl, C1 to C5 alkoxy or C1 to C5 perfluoroalkyl.

4. A compound according to claim 1, wherein R2 is C1 to C9 alkyl, C4-C8 cycloalkyl, adamantyl or C5-C10 aryl, which may be substituted with C1 to C5 alkyl, C1 to C5 alkoxy, or C1 to C5 perfluoroalkyl.

5. A compound according to claim 1, wherein R3 is C1-C12 alkyl, adamantyl, C4-C8 cycloalkyl and C5-C10 aryl, which may be substituted with C1 to C5 alkyl, C1 to C5 alkoxy or.

6. A compound according to claim 1, wherein R1 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, menthyl, phenyl, o-toluyl, naphtyl, o-methoxyphenyl, o-ethoxyphenyl, di-(o-methoxy) phenyl, p-trifluoromethylphenyl, trimethylsilyl, triisopropylsilyl, tri-tert-butylsilyl, cyano, methylsulfonyl, toluylsulfonyl and trifluoromethylsulfonyl.

7. A compound according to claim 1, wherein R2 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, trifluoromethyl, cyclobutyl, cyclopentyl, cyclohexyl, 1-adamantyl, 2-adamantyl, phenyl, o-, m-, or p-methylphenyl, naphthyl.

8. A compound according to claim 1, wherein R3 is selected from methyl, ethyl, propyl, isopropyl, n-butyl, sec-butyl, tert-butyl, n-pentyl, n-pentyl (amyl), 2-pentyl (sec-pentyl), 3-pentyl, 2-methylbutyl, 3-methylbutyl (iso-pentyl or iso-amyl), 3-methylbut-2-yl, 2-methylbut-2-yl, 2,2-dimethylpropyl (neopentyl), n-hexyl, cyclobutyl, cyclopentyl, cyclohexyl, phenyl.

9. A compound according to claim 1, wherein R2 is C1 to C9 alkyl or C4-C8 cycloalkyl and R3 is C1 to C12 alkyl or C4-C8 cycloalkyl, in particular wherein R2 and R3 are C4-C8 cycloalkyl.

10. A compound according to claim 9, wherein R2 and R3 are cyclohexyl, or wherein R2 is iso-propyl or tert-butyl and R3 is cyclohexyl.

11. A compound according to claim 1, wherein R1 is selected from the group consisting of methyl, phenyl, o-tolyl and o-methoxyphenyl.

12. A process for preparing compounds according to claim 1 of formula I, wherein a ligand of type R1—C—(P(R2)₂)(P(R3)₃), wherein R1, R2 and R3 are as defined, is reacted with a palladium compound of type PdX₂ or Lₙ(PdX₂), wherein X, as defined above, is halogen, L is a neutral electron donor ligand, and n=1 or 2.

13. A process for preparing compounds according to claim 1 of formula II, wherein a ligand of type R1—CH—(P(R2)₂)(P(R3)₃)(X), wherein R1, R2 and R3 are as defined, is reacted with a palladium compound of type H₂PdX₄, PdX₂ or Lₙ(PdX₂), wherein X, as defined above, is halogen, L is a neutral electron donor ligand, and n=1 or 2.

14. A process for performing a coupling reaction, comprising the following steps:
providing a reaction mixture containing at least one substrate, a coupling partner and a metal complex according to claim 1; and
reacting the substrate with the coupling partner in the presence of the metal complex or its derivative to form a coupling product.

15. A process for performing a coupling reaction, comprising the following steps:
providing a metal complex according to a process according to claim 12;
providing a reaction mixture containing at least one substrate, a coupling partner and the metal complex; and
reacting the substrate with the coupling partner in the presence of the metal complex or its derivative to form a coupling product.

16. A process according to claim 14, wherein the coupling reaction can be selected from the group consisting of:
(i) catalytic hydrofunctionalization reactions of alkynes and alkenes;
(ii) catalytic hydroamination reactions of alkynes and alkenes;
(iii) catalytic O—H addition reactions on alkynes and alkenes;
(iv) catalytic coupling reactions;
(v) catalytic Kumada coupling reactions, Murahashi coupling reactions, Negishi coupling reactions or Suzuki coupling reactions, in particular for the preparation of biarylene;
(vi) catalytic cross-coupling reactions, in particular C—N and C—O coupling reactions; and/or
(vii) catalytic Heck coupling reactions, in particular for the preparation of arylated olefins, and Sonogashira coupling reactions, in particular for the preparation of arylated and alkenylated alkynes.

17. A process for performing a coupling reaction, comprising the following steps:
providing a metal complex according to a process according to claim 13;
providing a reaction mixture containing at least one substrate, a coupling partner and the metal complex; and
reacting the substrate with the coupling partner in the presence of the metal complex or its derivative to form a coupling product.

18. A process according to claim 15, wherein the coupling reaction can be selected from the group consisting of:
(i) catalytic hydrofunctionalization reactions of alkynes and alkenes;
(ii) catalytic hydroamination reactions of alkynes and alkenes;
(iii) catalytic O-H addition reactions on alkynes and alkenes;
(iv) catalytic coupling reactions;
(v) catalytic Kumada coupling reactions, Murahashi coupling reactions, Negishi coupling reactions or Suzuki coupling reactions, in particular for the preparation of biarylene;
(vi) catalytic cross-coupling reactions, in particular C—N and C—O coupling reactions; and/or
(vii) catalytic Heck coupling reactions, in particular for the preparation of arylated olefins, and Sonogashira coupling reactions, in particular for the preparation of arylated and alkenylated alkynes.
